(19) United States
(12) Patent Application Publication
(10) Pub. No.: US 2013/0059283 A1
(43) Pub. Date: Mar. 7, 2013

(54) DEMENTIA CARE SUPPORT SYSTEM

(71) Applicants: Ayae NAGAOKA, Osaka (JP); Ichiko SATA, Osaka (JP)

(72) Inventors: Ayae NAGAOKA, Osaka (JP); Ichiko SATA, Osaka (JP)

(73) Assignee: SHARP KABUSHIKI KAISHA, Osaka (JP)

(21) Appl. No.: 13/478,716

(22) Filed: May 23, 2012

(30) Foreign Application Priority Data
Sep. 7, 2011 (JP) 2011-195076

(51) Int. Cl. G09B 7/00

(52) U.S. Cl. 434/362

(57) ABSTRACT

A doctor is supported so that the doctor is able to present appropriate countermeasures corresponding to a symptom of a patient to the patient and a caregiver. A storage portion stores information of a question to be given to a patient of dementia or a caregiver of the patient; a countermeasure information selection portion selects any of the countermeasure information that is stored in the storage portion based on information of an answer of the patient or the caregiver to the question; and a countermeasure information output portion outputs the countermeasure information that is selected by the countermeasure information selection portion.

### CROSS-NOTING PARAGRAPH

This non-provisional application claims priority under 35 U.S.C. §119 (a) on Patent Application No. 2011-195076 filed in JAPAN on Sep. 7, 2011, the entire contents of which are hereby incorporated herein by reference.

### FIELD OF THE INVENTION

The present invention relates to a dementia care support system for outputting countermeasure information to dementia.

### BACKGROUND OF THE INVENTION

It is said that one out of four people of 85 years of age or more develops dementia, which number is expected to be doubled in the next 20 years with the super-aging society just around the corner. However, dementia will never be completely healed, which significantly increases burdens on a patient and a caregiver. Therefore, it is desired that a symptom level is correctly diagnosed to take an appropriate countermeasure, thereby delaying the progress of dementia, which brings confidence and pride of a patient into recovery so that the patient and a caregiver are able to live healthily together.

Conventionally, systems have been proposed for supporting a diagnosis of a dementia level of a patient by a doctor. For example, Japanese Laid-Open Patent Publication No. 2007-282992 discloses a dementia diagnosis support system in which a patient is asked unfixed questions corresponding to behavior and an attribute of the patient to judge a correct or incorrect answer thereof, so that a dementia level of the patient is easily diagnosed, while it is possible to stimulate the patient based on RO (Reality Orientation).

Further, Japanese Laid-Open Patent Publication No. 2010-259634 discloses a dementia test support system in which a healthcare professional is provided with previous knowledge for conducting a dementia test, precautions for conducting the dementia test, behavior to be taken by the healthcare professional in conducting of the dementia test, an evaluation method of a response from a subject to the behavior of the healthcare professional, and score data for converting the response from the subject in the dementia test into a score, so that it is possible to obtain a uniform test result independent of proficiency in the dementia test of the healthcare professional.

However, the above-described conventional arts are provided for performing a diagnosis, a test and the RO of dementia of a patient, and not for presenting a countermeasure for dementia. It is desirable not only to simply present a diagnosis result and a test result but also to present an appropriate countermeasure selected corresponding to a core symptom caused by dementia (symptom of amnesia, disorientation, agnea, apraxia or aphasia) and a peripheral symptom occurring with the core symptom (psychological symptom such as anxiety, dysphoria, hallucination or delusion, and behavior disorder such as wandering or filthy behavior), however, the above-described conventional arts are not provided for performing such processing.

### SUMMARY OF THE INVENTION

An object of the present invention is to provide a dementia care support system capable of supporting a doctor so that the doctor is able to present an appropriate countermeasure corresponding to a symptom of a patient to the patient and a caregiver.

A first technical means of the present invention is a dementia care support system for outputting countermeasure information to dementia, comprising: a storage portion for storing information of questions given to a patient of the dementia or a caregiver of the patient and the countermeasure information to the dementia; a countermeasure information selection portion for selecting any of the countermeasure information stored in the storage portion based on information of an answer of the patient or the caregiver to the question; and a countermeasure information output portion for outputting the countermeasure information selected by the countermeasure information selection portion.

A second technical means of the present invention is the dementia care support system as defined in the first technical means, wherein the countermeasure information selection portion selects any of the countermeasure information based on the information of the answer and information of behavior or affect of the patient or the caregiver when a question is given to the patient or the caregiver.

A third technical means of the present invention is the dementia care support system as defined in the second technical means, further comprising: a behavior/affect information alternative setting portion for setting, information of behavior or affect to be included in the alternatives based on a frequency of the information of behavior or affect that is received by the text input when the information of behavior or affect of the patient or the caregiver is received by selection from among alternatives or text input.

A fourth technical means of the present invention is the dementia care support system as defined in the first technical means, further comprising: a question information search portion for searching the information of questions given to the patient or the caregiver based on information of a result of an answer to a question that has been already given to the patient or the caregiver; and a question information output portion for outputting information of a question that is searched by the question information search portion.

A fifth technical means of the present invention is the dementia care support system as defined in the fourth technical means, wherein when a question desired by a user is not searched by the question information search portion, the question information output portion outputs the question input by the user as a question to be given to the patient or the caregiver.

A sixth technical means of the present invention is the dementia care support system as defined in the first technical means, further comprising: the question information search portion for searching the information of a question given to the patient or the caregiver based on information of degree of progress of dementia of the patient; and the question information output portion for outputting the information of a question searched by the question information search portion.

A seventh technical means of the present invention is the dementia care support system as defined in the sixth technical means, wherein when a question desired by a user is not searched by the question information search portion, the question information output portion outputs the question input by the user as a question to be given to the patient or the caregiver.

An eighth technical means of the present invention is the dementia care support system as defined in the first technical means, further comprising: an answer alternative setting portion for setting, when the answer is received by any of selection from among alternatives or text input, an answer to be included in the alternatives based on a frequency of the answer that is received by the text input.

A ninth technical means of the present invention is the dementia care support system as defined in the first technical means, further comprising: an edit information receiving portion for receiving countermeasure information after the editing when countermeasure information that is selected by the countermeasure information selection portion is edited, wherein the storage portion stores the countermeasure information after editing that is received by the edit information receiving portion.

### BRIEF DESCRIPTION OF THE DRAWINGS

FIG. 1 is a diagram showing an example of a configuration of a dementia care support system according to an embodiment of the present invention;

FIG. 2 is a diagram showing an example of a configuration of a terminal device according to an embodiment of the present invention;

FIG. 3 is a diagram showing an example of a configuration of a dementia care support apparatus according to an embodiment of the present invention;

FIG. 4 is a flowchart showing an example of a processing procedure of dementia care support processing according to an embodiment of the present invention;

FIG. 5 is a flowchart showing an example of a processing procedure of question information transmission processing according to an embodiment of the present invention;

FIG. 6 is a flowchart showing an example of a processing procedure of answer and behavior/affect receiving processing according to an embodiment of the present invention;

FIG. 7 is a flowchart showing an example of a processing procedure of countermeasure information transmission processing according to an embodiment of the present invention;

FIG. 8 is a diagram showing an example of a reception screen for receiving information of an answer of a patient and behavior or affect of the patient;

FIG. 9 is a diagram showing an example of a reception screen for receiving information of behavior or affect of a caregiver when a patient answers;

FIG. 10 is a diagram showing an example of a reception screen for receiving information of a response of a caregiver and behavior or affect of the caregiver; and

FIG. 11 is a diagram showing an example of a reception screen for receiving information of behavior or affect of a patient when a caregiver answers.

### PREFERRED EMBODIMENTS OF THE INVENTION

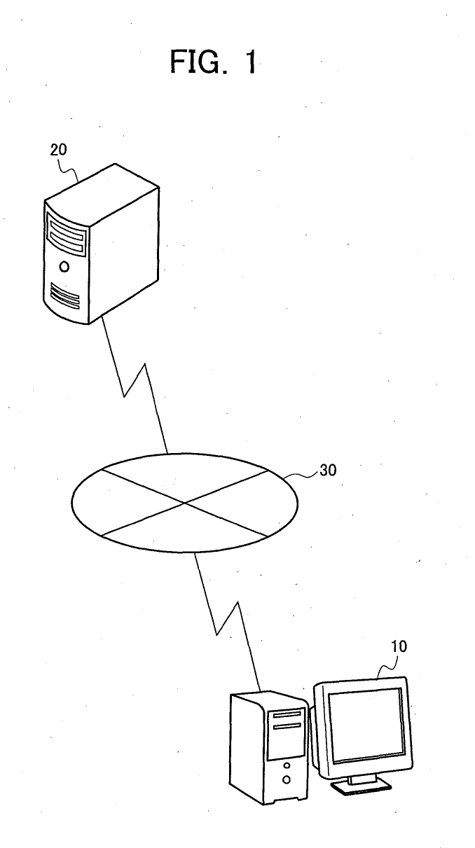

Hereinafter, embodiments of the present invention will be described in detail with reference to drawings. FIG. 1 is a diagram showing an example of a configuration of a dementia care support system according to an embodiment of the present invention. As shown in FIG. 1, in the dementia care support system, a terminal device 10 is connected to a dementia care support apparatus 20 via a network 30. Note that, the network 30 may be a wired network or a wireless network.

The terminal device 10 is a terminal device such as a personal computer or a smartphone for accessing the dementia care support apparatus 20 to obtain various information concerning dementia care, and providing the obtained information to a patient, a caregiver, a doctor and the like. Here, the caregiver refers to a family of a patient, care staff of a welfare facility and a specially designated health facility, or the like. The dementia care support apparatus 20 is a server apparatus for providing a wide range of information concerning dementia care to the terminal device 10.

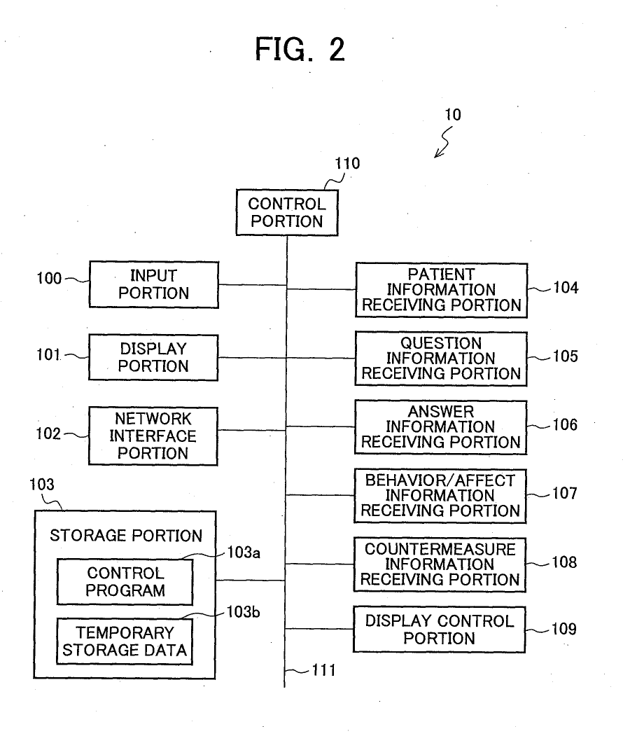

FIG. 2 is a diagram showing an example of a configuration of the terminal device 10 according to an embodiment of the present invention. The terminal device 10 is provided with an input portion 100, a display portion 101, a network interface portion 102, a storage portion 103, a patient information receiving portion 104, a question information receiving portion 105, an answer information receiving portion 106, a behavior/affect information receiving portion 107, a countermeasure information receiving portion 108, a display control portion 109 and a control portion 110. Function portions 100 to 110 are connected to one another via a bus 111, respectively.

The input portion 100 is an input device such as a keyboard, a mouse or a touch pad. The display portion 101 is a display device such as a liquid crystal display. The input portion 100 and the display portion 101 may be touch panels. Such a touch panel has preferably a size of 3 inches to 15 inches. The touch panel in such a size is provided for easily viewing information of a question or a countermeasure and inputting information of an answer and behavior or affect, as well as being suitable also for carrying.

The network interface portion 102 is a network interface connecting to another device such as the dementia care support apparatus 20 via the network 30.

The storage portion 103 is a storage device such as a flash ROM (Read Only Memory), an EEPROM (Electrically Erasable and Programmable ROM) or an HD (Hard Disk).

The storage portion 103 stores a control program 103a, temporary storage data 103b and the like. The control program 103a is a computer program which is read by the control portion 110 and causes the terminal device 10 to execute various processing. The temporary storage data 103b is data that is temporarily stored in the terminal device 10 such as data that is input by a doctor via the input portion 100 and data that is received via the network 30.

The patient information receiving portion 104 is a processing portion for receiving patient information that is input by a doctor via the input portion 100 to transmit the patient information to the dementia care support apparatus 20 via the network interface portion 102.

The patient information includes basic information of a patient's name, age, address, family structure, living situation and the like, information of a test for a dementia diagnosis taken by a patient and a diagnosis result thereof (information of a core symptom and a peripheral symptom, information of a score result of a test for a dementia diagnosis), information of a patient's medical history and drug history and the like.

The test for a dementia diagnosis includes, for example, the Mini Mental State Examination (MMSE), the Japanese version of the Rivermead Behavioural Memory Test (Japanese version of the RBMT), a dementia test such as the Frontal Assessment Battery (FAB), a Magnetic Resonance Imaging (MRI) test, a Single Photon Emission Computed Tomography test (SPECT), a blood test, an electrocardiogram examination, a chest X-ray and the like. The core symptom is able to be associated with the degree of progress of dementia of a patient as described below.

The question information receiving portion 105 is a processing portion for receiving information of a question that is asked a patient or a caregiver of the patient input by a doctor via the input portion 100 to transmit the information to the dementia care support apparatus 20 via the network interface portion 102. For example, in a case where information of the question that is received from the dementia care support apparatus 20 does not include desired information, the question information receiving portion 105 receives information of a question that is newly created by a doctor.

Thereby, a doctor uniquely creates a question to allow the question to be available also for another patient, thereby making it possible to grasp a symptom of a patient from a different view to enrich the basis for the decision to know the symptom.

The answer information receiving portion 106 is a processing portion for receiving information of an answer that is input by a doctor via the input portion 100 to transmit the information of an answer to the dementia care support apparatus 20 via the network interface portion 102. Such input of an answer is performed by selection from among alternatives or text input.

The behavior/affect information receiving portion 107 is a processing portion for receiving information of behavior or affect of a patient or a caregiver input by a doctor via the input portion 100 to transmit the information to the dementia care support apparatus 20 via the network interface portion 102. Such input of information of behavior or affect is performed by selection from among alternatives or text input.

The countermeasure information receiving portion 108 is a processing portion for receiving countermeasure information to dementia input by a doctor via the input portion 100 to transmit the countermeasure information to the dementia care support apparatus 20 via the network interface portion 102. For example, the countermeasure information receiving portion 108 receives, when a doctor edits a part of the countermeasure information received from the dementia care support apparatus 20, the countermeasure information edited by the doctor. Further, the countermeasure information receiving portion 108 receives new countermeasure information which is uniquely created by a doctor.

The display control portion 109 is a control portion for controlling display of information for the display portion 101. For example, the display control portion 109 controls the display portion 101 to perform processing for displaying information received from the dementia care support apparatus 20 on the display portion 101.

The control portion 110 is a control device such as a CPU (Central Processing Unit) and an MPU (Micro Processing Unit) for controlling each of the function portions 100 to 109 of the terminal device 10 and executing the control program 103a that is stored in the storage portion 103.

Note that, a printer may be connected to the terminal device 10 to print countermeasure information that is received from the dementia care support apparatus 20.

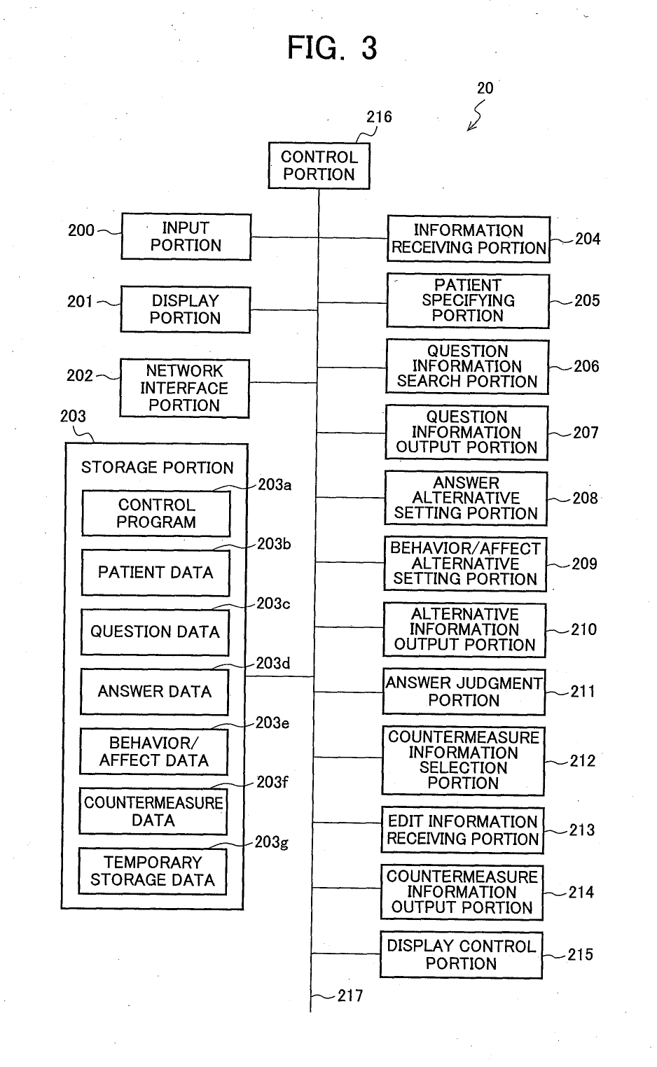

Next, a configuration of the dementia care support apparatus 20 will be described according to an embodiment of the present invention. FIG. 3 is a diagram showing an example of a configuration of the dementia care support apparatus 20 according to an embodiment of the present invention. The dementia care support apparatus 20 is provided with an input portion 200, a display portion 201, a network interface portion 202, a storage portion 203, an information receiving portion 204, a patient specifying portion 205, a question information search portion 206, a question information output portion 207, an answer alternative setting portion 208, a behavior/affect alternative setting portion 209, an alternative information output portion 210, an answer judgment portion 211, a countermeasure information selection portion 212, an edit information receiving portion 213, a countermeasure information output portion 214, a display control portion 215 and a control portion 216. Function portions 200 to 216 are connected to one another via a bus 217, respectively.

The input portion 200 is an input device such as a keyboard or a mouse. The display portion 201 is a display device such as a liquid crystal display. The network interface portion 202 is a network interface connecting to another device such as the terminal device 10 via the network 30.

The storage portion 203 is a storage device such as a flash ROM (Read Only Memory), an EEPROM (Electrically Erasable and Programmable ROM) or an HD (Hard Disk).

The storage portion 203 stores a control program 203a, patient data 203b, question data 203c, answer data 203d, behavior/affect data 203e, countermeasure data 203f, temporary storage data 203g and the like.

The control program 203a is a computer program that is read by the control portion 216 and causes the dementia care support apparatus 20 to execute various processing. The patient data 203b is data in which patient information that is received from the terminal device 10 is stored. Further, in the patient data 203b, countermeasure information that is used only for a specific patient and edited by a doctor is stored in association with patient information of the patient.

The question data 203c is data in which information of a question that is asked a patient or a caregiver of the patient is stored. A question type flag that distinguishes among a question concerning patient information, a question concerning a particular symptom, and a question for both a patient and a caregiver is added to information of each question.

In the question data 203c, information of a question, the question type flag, information of a core symptom and a peripheral symptom as indication representing the degree of progress of dementia, information of alternatives of an answer for a question, and information of alternatives of behavior or affect which is seen at the time of asking a question are stored correlating with each other.

A core symptom refers to a symptom of amnesia, disorientation, agnea, apraxia or aphasia. A peripheral symptom refers to a psychological symptom such as anxiety, dysphoria, hallucination or delusion, and behavior disorder such as fugue or filthy behavior. For example, a core symptom of amnesia appears in the initial stage of dementia, a core symptom of disorientation appears in the intermediate stage, and a core symptom such as agnea, apraxia or aphasia appears in the latter stage. Therefore, it is possible to represent the degree of progress of dementia using the core symptom.

Therefore, it is possible to search a question corresponding to the degree of progress of dementia in the case of specifying a core symptom. Then, a countermeasure is selected based on information of an answer for such a question and behavior or affect that is seen at the time of asking a question, so that it is possible to present a countermeasure for solving factors of the core symptom and a peripheral symptom along therewith to a patient and a caregiver. Moreover, a question corresponding to the degree of progress of dementia is selected from among many questions so that it is possible to present an appropriate countermeasure according to the symptom of a patient.

Note that, it is assumed that in a case where information of a plurality of questions is associated with a core symptom to be registered in the question data 203c, information of priority is added to information of each question. Then, when a core symptom is specified, search is conducted from high-priority information of a question.

Further, when information of a question that is newly created by a doctor, information of the question type flag, information of a core symptom and a peripheral symptom and information of priority are transmitted from the terminal device 10, such information is stored in the question data 203c in addition to information that is registered in advance.

Note that, questions included in the question data 203c may include questions that are used for known dementia tests such as the Mini Mental State Examination (MMSE), the Japanese version of the Rivermead Behavioural Memory Test (Japanese version of the RBMT) and the Frontal Assessment Battery (FAB). Such questions are included in the question data 203c to be reflected for selection of a question or selection of a countermeasure so that it is possible to present a countermeasure suitable for a patient.

The answer data 203d is data in which information of an answer received from the terminal device 10 is stored. The answer data 203d includes information of an answer that is selected by selection from among alternatives and information of an answer that is input by text input. Then, the information of the answer that is input by text input is stored together with information of a frequency of each answer.

The behavior/affect data 203e is data in which information of behavior or affect of a patient or a caregiver that is received from the terminal device 10 is stored. The behavior/affect data 203e includes information of behavior or affect that is selected by selection from among alternatives, and information of behavior or affect that is input by text input. Then, the information of behavior or affect that is input by text input is stored together with information of a frequency of each behavior or affect.

The countermeasure data 203f is data in which countermeasure information for dementia is stored. In the countermeasure data 203f, the countermeasure information is stored in association with information of a question, information of answers of a patient, a caregiver, or both a patient and a caregiver, information of behavior or affect of a patient and a caregiver while the patient answers a question, information of behavior or affect of a patient and a caregiver while the caregiver answers a question, information of a core symptom (degree of progress of dementia) and a peripheral symptom and patient information. The countermeasure information includes information of what causes a symptom, a patient's situation, a point in which a patient persists, a feature of a symptom of a patient, and devices and countermeasures for improving the symptom, and the like.

The countermeasure data 203f includes countermeasure information that is newly created by a doctor and used for an unspecified patient in addition to countermeasure information that is registered in advance. Note that, countermeasure information that is edited by a doctor is used only for a specified patient, and thus associated with patient information of the patient to be stored in the patient data 203b, however, the countermeasure information that is edited by a doctor may be stored in the countermeasure data 203f. In this case, the countermeasure information after editing may be stored in association with countermeasure information before editing without updating the countermeasure information before editing.

The temporary storage data 203g is data that is temporarily stored in the dementia care support apparatus 20 such as data received via the network 30.

The information receiving portion 204 is a processing portion for receiving information that is input by a doctor via the input portion 200 and information that is transmitted from another device such as the terminal device 10 via the network 30 to store the received information in the storage portion 203.

The patient specifying portion 205 is a processing portion for specifying, in a case where information of a patient's name, designation and the like is transmitted from the terminal device 10, a patient as a processing target using the information to read patient information corresponding to the specified patient from the patient data 203b.

The question information search portion 206 is a processing portion for searching information of a question that is asked a patient specified by the patient specifying portion 205 or a caregiver of the patient from the storage portion 203. For example, the question information search portion 206 searches information of a question corresponding to a core symptom of the patient from the question data 203c.

Additionally, when information of a plurality questions is registered in the question data 203c in association with a core symptom, the question information search portion 206 refers to information of priority of each question to conduct search from high-priority information of a question.

Note that, in a case where there are a plurality of core symptoms corresponding to a certain degree of progress, a typical question for finding the most severe core symptom is asked a patient or a caregiver, and the question information search portion 206 may judge the most severe core symptom from the result, then search information of a question corresponding to the core symptom. The typical question is, for example, a question for examining whether or not a patient has a cause to develop a core symptom.

In this case, the question information search portion 206 transmits information of a typical question for finding the most severe core symptom to the terminal device 10 via the network interface portion 202, and obtains information of an answer that is transmitted from the terminal device 10 for making the above-described judgment.

Further, in a case where there are a plurality of causes to develop a core symptom, the question information search portion 206 may ask a patient or a caregiver of the patient a subsidiary question for finding what has caused development of the core symptom to specify a cause from the result. The specified cause is transmitted to the terminal device 10 with countermeasure information.

In this case, information of a plurality of causes to develop the core symptom and information of a question for finding what has caused development of the core symptom are stored in the question data 203c in association with a core symptom. Then, in a case where a core symptom is specified, the question information search portion 206 refers to the question data 203c to judge whether or not there are plurality of causes for the core symptom. Then, in a case where there are a plurality of causes for the core symptom, the question information search portion 206 searches information of question for finding what has caused development of the specified core symptom.

The question information output portion 207 is a processing portion for transmitting the information of a question that is searched by the question information search portion 206 to the terminal device 10 via the network interface portion 202. Such information of a question may include not only information of a question that is stored in the storage portion 203 as the question data 203c in advance but also information of a question that is newly created by a doctor.

The answer alternative setting portion 208 is a processing portion for setting, in the case of receiving an answer of a question asked a patient or a caregiver by any of selection from among alternatives or text input, an answer that is included in alternatives based on a frequency of an answer that is received by text input.

In this case, the answer alternative setting portion 208 selects a predetermined number of answers from highly-frequent answers. Then, the answer alternative setting portion 208 sets the selected answer as an alternative to be displayed when the terminal device 10 prompts a doctor to input an answer.

This makes it possible to include any answers in alternatives without exception so that a doctor does not have to input an answer as text, thus making it possible to reduce an input time. Note that, the above-described predetermined number is not particularly limited, but is preferably set to three to six.

The behavior/affect alternative setting portion 209 is a processing portion for setting information of behavior or affect included in alternatives based on a frequency of information of behavior or affect that is received by text input when the terminal device 10 receives information of behavior or affect of a patient or a caregiver by selection from among alternatives or text input.

In this case, the behavior/affect alternative setting portion 209 selects a predetermined number of information of behavior or affect from highly-frequent information of behavior or affect. Then, the behavior/affect alternative setting portion 209 sets the selected information of behavior or affect as an alternative to be displayed when the terminal device 10 prompts a doctor to input information of behavior or affect.

This makes it possible to include any information of behavior or affect in alternatives without exception so that a doctor does not have to input information of behavior or affect as text, thus making it possible to reduce an input time. Note that, the above-described predetermined number is not particularly limited, but is preferably set to three to six.

The alternative information output portion 210 is a processing portion for transmitting information of an alternative that is set by the answer alternative setting portion 208 or the behavior/affect alternative setting portion 209 to the terminal device 10 via the network interface portion 202.

The answer judgment portion 211 is a processing portion for judging whether or not an answer of a patient is correct and whether or not a patient has a specific symptom. Specifically, the answer judgment portion 211 reads information of the question type flag of a question corresponding to an answer of a patient from the question data 203c to judge which of a question concerning patient information, a question concerning a specific symptom and a question for both a patient and a caregiver corresponds to the question.

Then, when the question is the question concerning patient information, the answer judgment portion 211 judges whether or not the answer of the patient is correct by checking an answer of a patient against patient information that is stored in the patient data 203b.

Further, when the question is the question concerning a specific symptom, the answer judgment portion 211 judges that a patient has a specific symptom in the case of receiving from the terminal device 10 an answer that there is a specific symptom.

Moreover, when the question is the question for both a patient and a caregiver, the answer judgment portion 211 judges whether or not the answer of the patient is correct by checking an answer of a patient against an answer of a caregiver.

The countermeasure information selection portion 212 is a processing portion for selecting any of countermeasure information that is stored as the countermeasure data 203f in the storage portion 203 based on all or at least one or more information of information of a result of judgment made by the answer judgment portion 211 and answers of a patient and a caregiver, information of behavior or affect of a patient and a caregiver, information of a core symptom (degree of progress of dementia) and a peripheral symptom, and patient information.

Specifically, the countermeasure information selection portion 212 selects from among countermeasure information that is stored in the countermeasure data 203f countermeasure information corresponding to all or at least one or more information of information of a question that an answer of a patient is not correct, information of answers of a patient and a caregiver, information of behavior or affect of a patient and a caregiver at the time of asking questions, information of a core symptom (degree of progress of dementia) and a peripheral symptom, and patient information.

The edit information receiving portion 213 is a processing portion for obtaining, when a doctor operates the terminal device 10 to edit countermeasure information selected by the countermeasure information selection portion 212, countermeasure information after such editing to store the obtained countermeasure information in the patient data 203b of the storage portion 203 in association with patient information of a patient to be currently judged, or store the countermeasure information in the countermeasure data 203f of the storage portion 203 in association with countermeasure information before editing.

The countermeasure information output portion 214 is a processing portion for transmitting countermeasure information selected by the countermeasure information selection portion 212 or countermeasure information after editing obtained by the edit information receiving portion 213 to be stored in the storage portion 203 to the terminal device 10 via the network interface portion 202. The countermeasure information selected by the countermeasure information selection portion 212 may include countermeasure information that is newly created by a doctor.

In this manner, countermeasure information newly created by a doctor is managed by the dementia care support apparatus 20 to be used for dementia care for various patients, thereby making it possible to present a more appropriate countermeasure to a patient and a caregiver. Moreover, countermeasures are enriched so that it is possible to increase alternatives of countermeasures which are able to be attempted by a patient and a caregiver.

Further, the countermeasure information output portion 214 reads patient information from the patient data 203b, reads information of an answer of a patient or a caregiver from the patient data 203b, or reads information of behavior or affect from the behavior/affect data 203e, and transmits the read information to the terminal device 10 via the network interface portion 202.

Thereby, a doctor is able to compare information of a test for a dementia diagnosis taken by a patient and a diagnosis result thereof (information of a core symptom and a peripheral symptom, and information of a score result of a test for a dementia diagnosis) and information of a patient's medical history and drug history to information of an answer of a patient or a caregiver, information of behavior or affect of a patient or a caregiver and countermeasure information, then grabs a temporal change of a symptom of a patient so that it is possible to confirm an effect of a countermeasure. Additionally, a doctor is able to predict a future symptom from the temporal change to reflect it on selection of a question and selection of a countermeasure.

The display control portion 215 is a control portion for controlling display of information for the display portion 201. The control portion 216 is a control device such as a CPU (Central Processing Unit) and an MPU (Micro Processing Unit) for controlling each of the function portions 200 to 215 of the dementia care support apparatus 20 while executing the control program 203a that is stored in the storage portion 203.

As described above, the dementia care support apparatus 20 serves as a server to select information of a question and a countermeasure and accumulate information of a patient, information of a question, information of an answer, information of behavior or affect and the like to provide such information via the network 30, thereby sharing information in a certain area of a hospital, a community, a country or the like, or among hospitals around the world, so that it is possible to view or use a question, a countermeasure and the like which are uniquely created by a certain doctor in a wide range of areas. Further, a patient and a caregiver are also able to view patient information and a countermeasure.

Moreover, the terminal device 10 performs display of information of a question or a countermeasure and input of patient information, information of an answer of a patient or a caregiver, information of behavior or affect and the like, and a place where to ask a question and present a countermeasure is thereby not limited. Additionally, it is possible to use the dementia care support system in a diagnosis by visit.

Further, each function portion included in the terminal device 10 and each function portion included in the dementia care support apparatus 20 has been described in the above-described embodiment, however, one apparatus may include each function portion of the terminal device 10 and each function portion of the dementia care support apparatus 20. Additionally, a part of each function portion that is included in the terminal device 10 may be included in the dementia care support apparatus 20, and a part of each function portion that is included in the dementia care support apparatus 20 may be included in the terminal device 10.

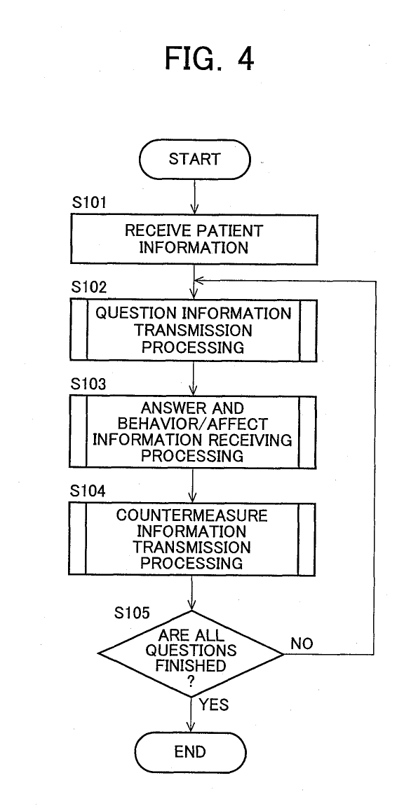

Next, a processing procedure of dementia care support processing will be described according to an embodiment of the present invention. FIG. 4 is a flowchart showing an example of a processing procedure of dementia care support processing according to an embodiment of the present invention.

When a doctor operates the terminal device 10 to input patient information and the patient information is transmitted to the dementia care support apparatus 20, the information receiving portion 204 of the dementia care support apparatus 20 receives the patient information to store the received patient information in the storage portion 203 as the patient data 203b (step S101).

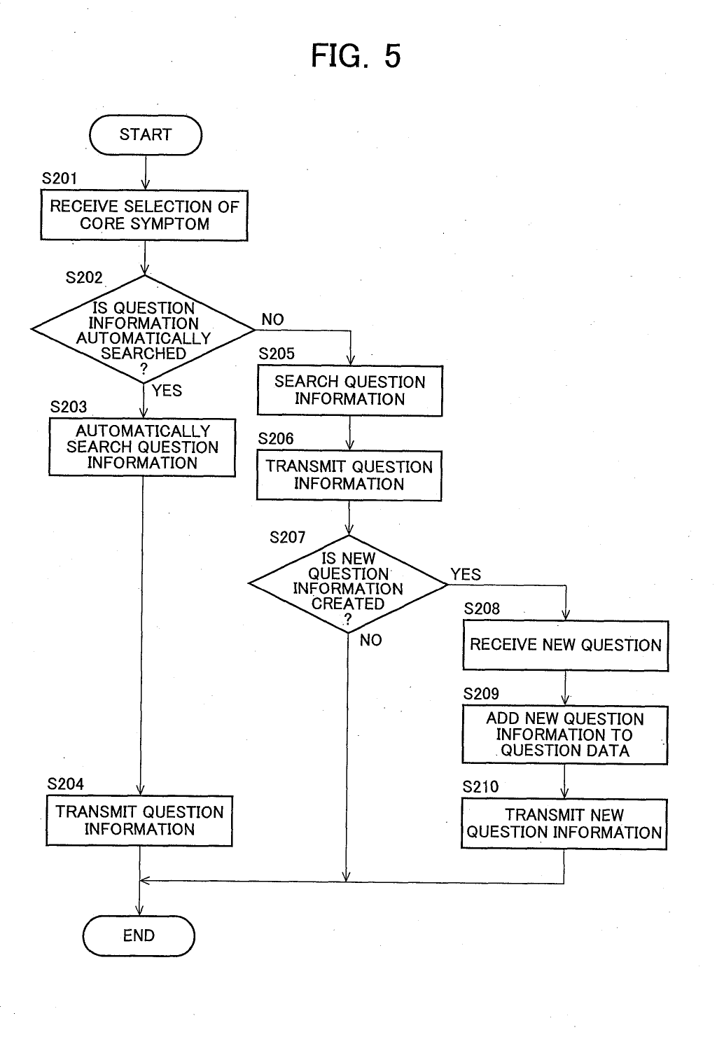

Then, the question information search portion 206 and the question information output portion 207 of the dementia care support apparatus 20 execute question information transmission processing for transmitting information of a question for a patient or a caregiver to the terminal device 10 (step S102). The transmitted information of a question is displayed on the display portion 101 of the terminal device 10. The question information transmission processing will be described in detail with reference to FIG. 5.

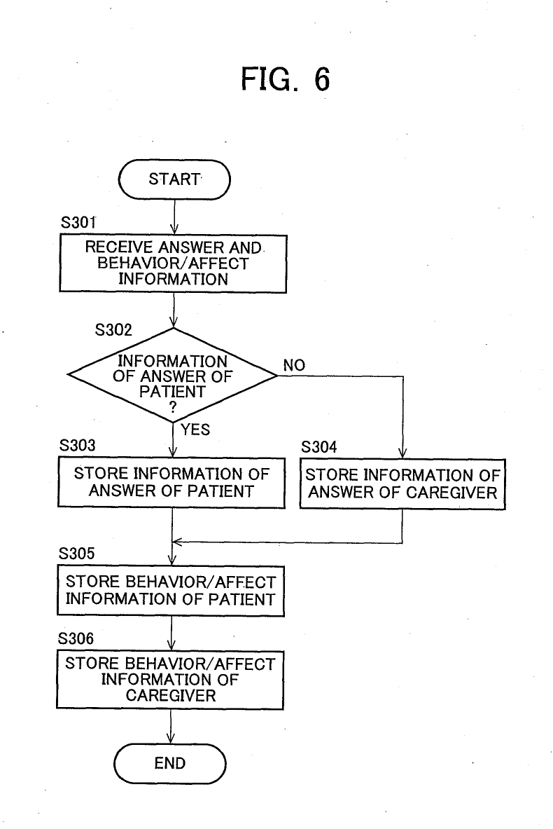

Then, when information of an answer to a question and information of behavior or affect of a patient or a caregiver are transmitted from the terminal device 10, the information receiving portion 204 of the dementia care support apparatus 20 executes answer and behavior/affect information receiving processing for receiving information of an answer and information of behavior or affect (step S103). The answer and behavior/affect information receiving processing will be described in detail with reference to FIG. 6.

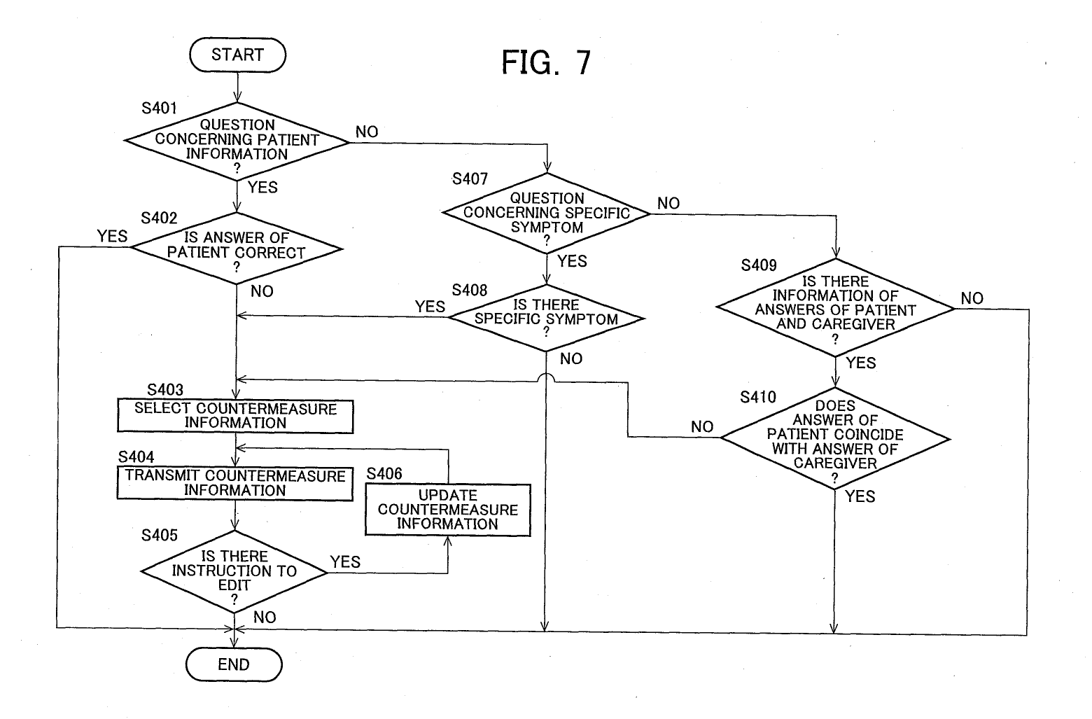

Then, the answer judgment portion 211, the countermeasure information selection portion 212 and the countermeasure information output portion 214 of the dementia care support apparatus 20 execute countermeasure information transmission processing for transmitting countermeasure information to dementia to the terminal device 10 based on information of an answer, information of behavior or affect of a patient or a caregiver, information of a core symptom (degree of progress of dementia) and a peripheral symptom, and patient information (step S104). The transmitted countermeasure information is displayed on the display portion 101 of the terminal device 10. The countermeasure information transmission processing will be described in detail with reference to FIG. 7.

Thereafter, the countermeasure information selection portion 212 of the dementia care support apparatus 20 judges whether or not all questions are completed (step S105). In the case of not completing all questions (in the case of NO at step S105), the process goes to step S102 to execute question information transmission processing for transmitting information of a next question for a patient or a caregiver. In the case of completing all questions (in the case of YES at step S105), the dementia care support processing is finished.

Next, the question information transmission processing at step S102 of FIG. 4 will be described in detail. FIG. 5 is a flowchart showing an example of a processing procedure of the question information transmission processing according to an embodiment of the present invention.

First, when a doctor operates the terminal device 10 to input patient information including a core symptom, and the patient information is transmitted to the dementia care support apparatus 20, the information receiving portion 204 of the dementia care support apparatus 20 obtains information of the core symptom from the patient information to receive the information as information of the core symptom of the patient (step S201).

Then, the question information search portion 206 of the dementia care support apparatus 20 judges whether or not a question to be asked a patient or a caregiver is set to be automatically searched (step S202). Such setting information is stored in the storage portion 203 or the like in advance, and changed as needed.

In a case where a question is set to be automatically searched (in the case of YES at step S202), the question information search portion 206 automatically searches a question (step S203). Specifically, the question information search portion 206 searches information of a question corresponding to a core symptom received at step S201 in descending order of priority from the question data 203c.

Note that, the question information search portion 206 may give priority to search of questions related to patient information, information of an answer to a question that has been previously asked a patient or a caregiver, information of behavior or affect of the patient or the caregiver at the time of receiving the answer, and the like.

For example, the question information search portion 206 may search questions corresponding to a part or all of the patient information received at step S101 of FIG. 4 in priority to questions other than those. In this case, in the question data 203c, basic information of a patient's name, age, address, family structure, living situation and the like, information of a test for a dementia diagnosis taken by a patient and a diagnosis result thereof (information of a core symptom and a peripheral symptom, information of a score result of a test for a dementia diagnosis), information of a patient's medical history and drug history and the like are associated with one another to be stored.

Then, the question information search portion 206 searches questions corresponding to a part or all of the patient information received at step S101 of FIG. 4 from the question data 203c.

Further, for example, the question information search portion 206 may give priority to search of a question that a previous answer of a patient was not correct, or a question that an answer of a patient has not coincided with an answer of a caregiver. In this case, the question information search portion 206 stores a flag for differentiating the above-described question from other questions in the question data 203c in association with information of the question described above, and refers to the flag to conduct search.

In a case where there are a plurality of questions that a previous answer of a patient was not correct or questions that an answer of a patient has not coincided with an answer of a caregiver, the question information search portion 206 may conduct search from a question to which a high priority is assigned among respective questions.

Additionally, for example, the question information search portion 206 may search information of answers to other questions previously asked the patient or the caregiver and questions corresponding to information of behavior or affect of the patient or the caregiver at the time of receiving the answers in priority to information of questions other than those. In this case, information of answers to other questions and information of behavior or affect are stored in the question data 203c in association with information of each question.

Then, the question information search portion 206 searches from the question data 203c the information of answers to other questions previously asked the patient or the caregiver and questions corresponding to information of behavior or affect of the patient or the caregiver at the time of receiving the answers.

Thereby, it is possible to confirm an implementation status and an effect of a countermeasure presented based on answers to questions previously asked, and to ask a question suitable for a symptom of a patient.

Further, in a case where there are a plurality of causes to develop dementia, the question information search portion 206 may search a question for determining which cause relates to a patient in priority to other questions. In this case, in the question data 203c, priority placed on a question for determining which cause relates to a patient may be set higher than priority of other questions.

Additionally, when the degree of progress of dementia advances farther than a predetermined level, the question information search portion 206 may search a question for a caregiver without searching a question for a patient. This is because advanced dementia lowers answer ability of a patient to lower reliability of answer details of the patient, which causes necessity of an answer from a caregiver to a question needing a correct answer.

Levels of the degree of progress of dementia are classified into, for example, an initial level in which a core symptom of amnesia appears, an intermediate level in which a core symptom of disorientation appears, and a later level in which a core symptom such as agnea, apraxia or aphasia appears.

In this case, a questionee flag for differentiating a question for a patient, a question for a caregiver, and questions for both a patient and a caregiver from one another is stored in the question data 203c in association with information of each question. Then, in a case where the degree of progress of dementia is advanced farther than the intermediate level in which a core symptom of disorientation appears, the question information search portion 206 may refer to the questionee flag that is stored in the question data 203c to search from high-priority information of a question for a caregiver.

After processing at step S203, the question information output portion 207 transmits information of a question searched by the question information search portion 206 to the terminal device 10 via the network interface portion 202 (step S204). Then, the question information transmission processing is finished.

Note that, when information of an answer to a question and behavior/affect of a patient or a caregiver is selected from alternatives by a doctor, information of those alternatives is transmitted to the terminal device 10 with information of a question.

Specifically, the answer alternative setting portion 208 reads information of alternatives of an answer that is associated with information of a question to be stored in the question data 203c, and the behavior/affect alternative setting portion 209 reads information of alternatives of behavior or affect that is associated with information of a question to be stored in the question data 203c, then the alternative information output portion 210 transmits information of those alternatives to the terminal device 10 via the network interface portion 202.

Here, it is assumed that when frequency of answer that is received by text input at the terminal device 10 is greater than a predetermined value, the answer alternative setting portion 208 includes information of the answer in information of alternatives of an answer. Further, it is assumed that when a frequency of information of behavior or affect that is received by text input at the terminal device 10 is greater than a predetermined value, the behavior/affect alternative setting portion 209 includes information of the behavior or the affect in information of alternatives of behavior or affect.

At step S202, in a case where a question that is asked a patient or a caregiver is not set to be automatically searched (in the case of NO at step S202), the question information search portion 206 uses information of a keyword that is transmitted from the terminal device 10 to conduct keyword search, or uses specified information of a category that is transmitted from the terminal device 10 to conduct category search (step S205). Such keyword information or specified information of a category is information input by operation of the terminal device 10 by a doctor.

Thereafter, the question information output portion 207 transmits information of a question searched by the question information search portion 206 to the terminal device 10 via the network interface portion 202 (step S206).

Note that, when information of an answer to a question and behavior or affect of a patient or a caregiver is selected from alternatives by a doctor, the alternative information output portion 210 transmits information of those alternatives to the terminal device 10 via the network interface portion 202. Further, the answer alternative setting portion 208 and the behavior/affect alternative setting portion 209 set information of an answer and behavior or affect to be included in alternatives based on frequency of answer that is received by text input.

Then, the question information search portion 206 judges whether or not to receive notification from the terminal device 10 that a new question is created (step S207). Such notification is transmitted from the terminal device 10 when a doctor operates the terminal device 10 to make a creation request of a new question.

When the information of an answer to a question and behavior or affect transmitted from the terminal device 10 at step S206 is transmitted without receiving notification from the terminal device 10 that a new question is created (in the case of NO at step S207), the question information transmission processing is finished.

In the case of receiving notification from the terminal device 10 that a new question is created (in the case of YES at step S207), the information receiving portion 204 receives the information of a new question that is transmitted from the terminal device 10 (step S208). Then, the information receiving portion 204 adds the information of a new question to the question data 203c (step S209).

Here, from the terminal device 10, in addition to the information of a new question, the question type flag, information of a core symptom and a peripheral symptom, information of alternatives of an answer to a question, information of alternatives of behavior or affect to be found at the time of asking a question and the like are transmitted together. The information receiving portion 204 stores the information of a new question in the question data 203c in association with such information.

Thereafter, the question information search portion 206 transmits the information of a new question added to the question data 203c to the terminal device 10 via the network interface portion 202 (step S210), and the question information transmission processing is finished. The terminal device 10 which receives such information displays the received information of a new question on the display portion 201 as a question to be asked a patient or a caregiver.

Additionally, here, it is assumed that the information of a new question is added to the question data 203c, however, information of alternatives of an answer and information of alternatives of behavior or affect may be newly received.

In this case, the answer alternative setting portion 208 obtains information of alternatives of an answer that is input by a doctor who operates the terminal device 10, and the answer alternative setting portion 208 associates the information of alternatives of an answer with information of a question to be stored in the question data 203c.

Further, the behavior/affect alternative setting portion 209 obtains information of alternatives of behavior or affect input by a doctor who operates the terminal device 10, and the behavior/affect alternative setting portion 209 associates the information of alternatives of behavior or affect with information of a question to be stored in the question data 203c.

Then, when the information of a question is transmitted to the terminal device 10, the alternative information output portion 210 transmits information of alternatives of an answer and information of alternatives of behavior or affect corresponding to the question to the terminal device 10 via the network interface portion 202.

The terminal device 10 which receives the information of alternatives of an answer and the information of alternatives of behavior or affect displays the information of alternatives of an answer and information of behavior or affect as alternatives, and receives selection of information of an answer and information of behavior or affect.

Next, the answer and behavior/affect receiving processing indicated at step S103 of FIG. 4 will be described. FIG. 6 is a flowchart showing an example of a processing procedure of the answer and behavior/affect receiving processing according to an embodiment of the present invention.

First, the information receiving portion 204 of the dementia care support apparatus 20 receives information of an answer of a patient or a caregiver and information of behavior or affect of a patient or a caregiver that are transmitted from the terminal device 10 (step S301). Here, the information of an answer and the information of behavior or affect are information of an item that is selected from among a plurality of alternatives or information input by text input.

Then, the information receiving portion 204 judges whether or not the received information of an answer is information of an answer of a patient (step S302). Note that, to the received information of an answer, an identification flag for identifying whether to be information of a patient or information of a caregiver at the terminal device 10 is added, and the information receiving portion 204 refers to such an identification flag to make the above-described judgment.

In a case where the received answer is the information of an answer of a patient (in the case of YES at step S302), the information receiving portion 204 stores the received information of an answer of a patient in the storage portion 203 together with the identification flag indicating to be the information of a patient as the answer data 203d (step S303).

In a case where the received answer is not the information of an answer of a patient (in the case of NO at step S302), the received answer is information of an answer of a caregiver, and the information receiving portion 204 thus stores the received information of an answer of a caregiver in the storage portion 203 together with the identification flag indicating to be the information of a caregiver as the answer data 203d (step S304).

After processing at step S303 or step S304, the information receiving portion 204 stores the information of behavior or affect of a patient received at step S301 in the storage portion 203 together with the identification flag indicating to be the information of a patient as the behavior/affect data 203e (step S305).

Additionally, the information receiving portion 204 stores the information of behavior or affect of a caregiver received at step S301 in the storage portion 203 together with the identification flag indicating to be the information of a caregiver as the behavior/affect data 203e (step S306), and the behavior/affect receiving processing is finished.

Next, the countermeasure information transmission processing indicated at step S104 of FIG. 4 will be described. FIG. 7 is a flowchart showing an example of a processing procedure of the countermeasure information transmission processing according to an embodiment of the present invention.

First, the answer judgment portion 211 of the dementia care support apparatus 20 judges whether or not a question relates to patient information which is asked a patient (step S401). Specifically, the information receiving portion 204 refers to the question type flag that is stored in the question data 203c to make the above-described judgment.

In a case where a question is the question related to the patient information that is asked a patient (in the case of YES at step S401), the answer judgment portion 211 checks the received information of an answer of a patient against the patient information that is stored in the patient data 203b to judge whether or not an answer of a patient is correct (step S402).

In a case where the answer of a patient is correct (in the case of YES at step S402), the countermeasure information transmission processing is finished accordingly to go to processing at step S105 of FIG. 4. In a case where the answer of a patient is not correct (in the case of NO at step S402), the countermeasure information selection portion 212 selects countermeasure information to dementia of a patient based on all or at least one or more information of information of answers of a patient and a caregiver, information of behavior or affect of a patient and a caregiver, information of a core symptom (degree of progress of dementia) and a peripheral symptom, and patient information (step S403).

Specifically, the countermeasure information selection portion 212 refers to the countermeasure data 203f to read the countermeasure information that is stored in the countermeasure data 203f in association with all or at least one or more information of information of answers of a patient and a caregiver, information of behavior or affect of a patient and a caregiver, information of a core symptom (degree of progress of dementia) and a peripheral symptom and patient information, and selects the read countermeasure information as countermeasure information to be transmitted to the terminal device 10. Note that, such countermeasure information includes countermeasure information that is newly created by a doctor to be stored in the countermeasure data 203f.

As described above, the countermeasure information includes information of what causes a symptom, a patient's situation, a point in which a patient persists, a feature of a symptom of a patient and devices and countermeasures for improving the symptom, and the like.

Then, the countermeasure information is selected based on information of behavior or affect of a caregiver while a patient answers a question and information of behavior or affect of a patient while a caregiver answers a question, thereby enabling to select an appropriate way of coping in consideration of intelligibility of a caregiver for a patient and a relation between a patient and a caregiver. Further, a feature of a symptom of a patient; a point in which a patient persists, intelligibility of a caregiver and a relation between a patient and a caregiver are clarified so that it is possible to present an appropriate countermeasure suitable for a patient and a caregiver.

After processing at step S403, the countermeasure information output portion 214 transmits the countermeasure information selected by the countermeasure information selection portion 212 to the terminal device 10 via the network interface portion 202 (step S404). Then, the terminal device 10 which receives the countermeasure information displays the countermeasure information.

Thereafter, as a result that the countermeasure information is displayed at the terminal device 10, the edit information receiving portion 213 judges whether or not editing instruction information of the countermeasure information is received from the terminal device 10 (step S405). The editing instruction information includes countermeasure information that is edited by operation of the terminal device 10 by a doctor.

In the case of receiving the editing instruction information of the countermeasure information from the terminal device 10 (in the case of YES at step S405), the edit information receiving portion 213 updates countermeasure information before editing that is stored in the countermeasure data 203f to countermeasure information after editing (step S406).

Then, the process goes to step S404, and the countermeasure information output portion 214 transmits the countermeasure information after editing to the terminal device 10 via the network interface portion 202 to continue subsequent processing.

In this manner, a doctor performs final confirmation of countermeasure information to edit a countermeasure so that it is possible to present more appropriate countermeasures to a patient and a caregiver corresponding to each of a patient and a caregiver.

When the editing instruction information of the countermeasure information is not received and information indicating that processing is completed from the terminal device 10 at step S405 (in the case of NO at step S405), the countermeasure information transmission processing is finished.

In a case where a question is not the question related to the patient information at step S401 (in the case of NO at step S401), the answer judgment portion 211 judges whether or not the question is a question related to presence/absence of a specific symptom such as a peripheral symptom (step S407). Specifically, the countermeasure information selection portion 212 refers to the question type flag that is stored in the question data 203c to make the above-described judgment.

In a case where the question is the question related to presence/absence of a specific symptom such as a peripheral symptom (in the case of YES at step S407), the answer judgment portion 211 judges whether an answer that there is a specific symptom is given or not (step S408).

In the case where the answer that there is a specific symptom is given (in the case of YES at step S408), the process goes to step S403, and the countermeasure information selection portion 212 selects countermeasure information to dementia of a patient based on all or at least one or more information of information of answers of a patient and a caregiver, information of behavior or affect of a patient and a caregiver, information of a core symptom (degree of progress of dementia) and a peripheral symptom and patient information to continue subsequent processing. In the case where an answer that there is no specific symptom is given (in the case of NO at step S408), the countermeasure information transmission processing is finished accordingly.

In a case where the question is not the question related to presence/absence of a specific symptom at step S407 (in the case of NO at step S407), the question must be a question for both of a patient and a caregiver. Therefore, the answer judgment portion 211 judges whether or not information of answers of both a patient and a caregiver is obtained to the same question (step S409).

In a case where the information of answers of both a patient and a caregiver is not obtained (in the case of NO at step S409), the countermeasure information transmission processing is finished accordingly. In a case where the information of answers of both a patient and a caregiver is obtained (in the case of YES at step S409), the answer judgment portion 211 judges whether or not the information of an answer of a patient coincides with the information of an answer of a caregiver (step S410) by checking information of an answer of a patient against information of an answer of a caregiver.

In a case where the information of an answer of a patient coincides with the information of an answer of a caregiver (in the case of YES at step S410), the countermeasure information transmission processing is finished accordingly. In a case where the information of an answer of a patient does not coincide with the information of an answer of a caregiver (in the case of NO at step S410), the process goes to step S403, and the countermeasure information selection portion 212 selects countermeasure information to dementia of a patient based on all or at least one or more information of information of answers of a patient and a caregiver, information of behavior or affect of a patient and a caregiver, information of a core symptom (degree of progress of dementia) and a peripheral symptom and patient information to continue subsequent processing.

Note that, it is assumed that editing of countermeasure information is received at step S406 of FIG. 7, however, addition of new countermeasure information may be received. In this case, the edit information receiving portion 213 obtains countermeasure information transmitted from the terminal device 10. Further, the edit information receiving portion 213 obtains, together with the countermeasure information, related information transmitted from the terminal device 10, that is, information such as information of a question, information of answers of a patient, a caregiver, or both a patient and a caregiver, information of behavior or affect of a patient and a caregiver while the patient answers a question, information of behavior or affect of a patient and a caregiver while the caregiver answers a question, information of a core symptom (degree of progress of dementia) and a peripheral symptom, and patient information.

Here, the countermeasure information and the related information are information that is input by operation of the terminal device 10 by a doctor so as to be newly added to the countermeasure data 203f. Then, the edit information receiving portion 213 stores the obtained countermeasure information in the countermeasure data 203f in association with the above-described related information.

In this manner, a doctor uniquely creates countermeasure information and the countermeasure information is allowed to be available also for other patients, thereby making it possible to present more appropriate countermeasures to a patient and a caregiver. Further, countermeasures are enriched so that it is possible to increase alternatives of countermeasures to be attempted by a patient and a caregiver.

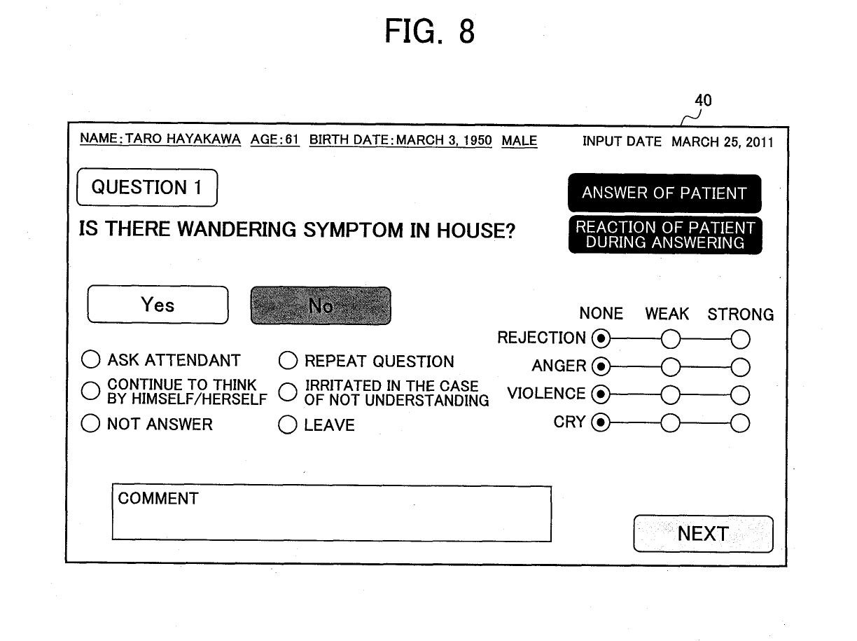

Next, a reception screen for receiving information of answers from a patient and a caregiver and behavior or affect will be described. FIG. 8 is a diagram showing an example of a reception screen 40 for receiving information of an answer of a patient and behavior or affect of the patient.

In the FIG. 8, an example is shown in which a doctor asks a patient a question that “Is there a wandering symptom in the house?” and the patient answers “No”. Further, on the reception screen 40, check boxes are shown for selecting information of behavior or affect that “Ask an attendant”, “Repeat a question”, “Continue to think by himself/herself”, “Irritated in the case of not understanding”, “Not answer” and “Leave”. However, any check box is not checked in FIG. 8. This means that there is no specific indication of behavior or affect of a patient as described above.

Additionally, on the reception screen 40, radio buttons are shown indicating a degree of reaction of a patient of “None”, “Weak” and “Strong” for information of behavior or affect of “Rejection”, “Anger”, “Violence” and “Cry”. However, radio buttons of “None” are selected for all of the information in FIG. 8. This means that there is no particular indication of the behavior or affect of a patient as described above.

In the case of FIG. 8, information of “NO” as information of an answer of a patient, and information of “None” as information of behavior or affect of a patient will be transmitted to the dementia care support apparatus 20.

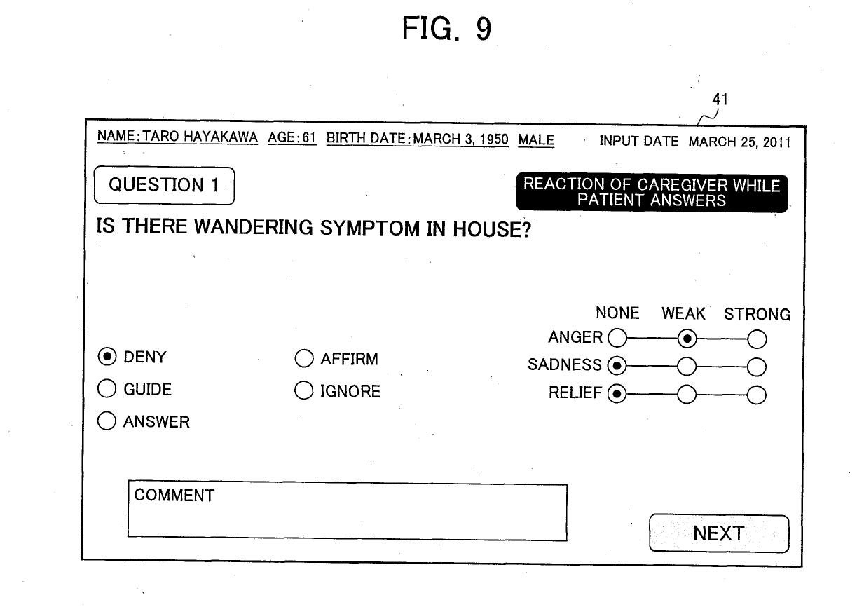

FIG. 9 is a diagram showing an example of a reception screen 41 for receiving information of behavior or affect of a caregiver when a patient answers. In FIG. 9, an example of the reception screen 41 is shown for receiving information of behavior or affect of a caregiver when a doctor asks a patient a question that “Is there a wandering symptom in the house?” and the patient answers “NO”.

On the reception screen 41, check boxes are shown for selecting information of behavior or affect of “Deny”, “Affirm”, “Guide”, “Ignore” and “Answer”. Then, “Deny” is selected in FIG. 9.

Further, on the reception screen 41, radio buttons are shown indicating a degree of reaction of a patient of “None”, “Weak” and “Strong” for information of behavior or affect of “Anger”, “Sadness” and “Relief”. Then, the radio button of “Weak” is selected for “Anger” in FIG. 9. That is, this example shows that there is a situation where a caregiver feels weak angry with respect to an answer of a patient of not wandering in the house, which is different from a fact.

In this case, as information of behavior or affect of the caregiver for the answer of “NO” by the patient to the question, information of “Deny” and information of “Anger, Weak” will be transmitted to the dementia care support apparatus 20.

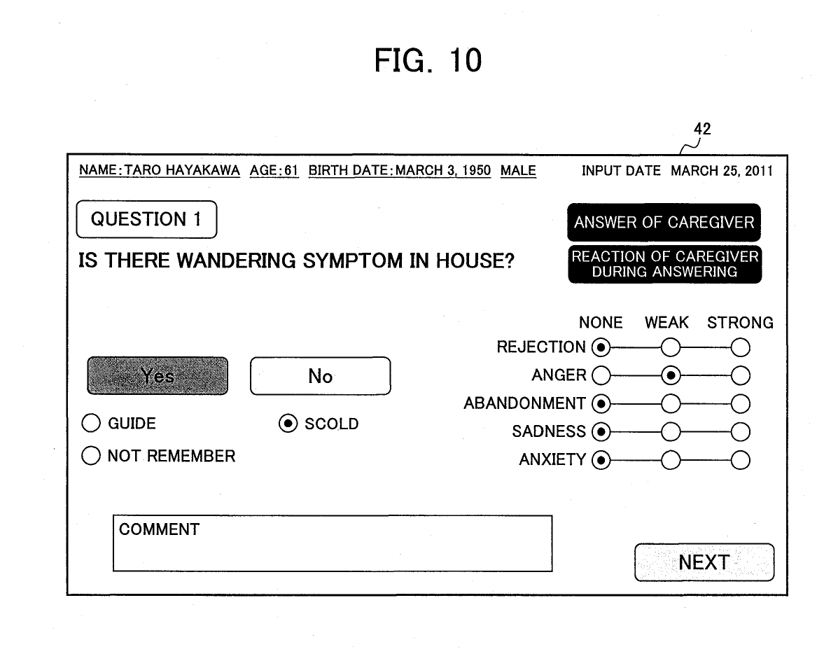

FIG. 10 is a diagram showing an example of a reception screen 42 for receiving information of a response of a caregiver and behavior or affect of the caregiver. In FIG. 10, an example of the reception screen 42 is shown for receiving information of behavior or affect of a caregiver when a doctor asks the caregiver a question that “Is there a wandering symptom in the house?” and the caregiver answers “Yes”.

Further, on the reception screen 42, check boxes are shown for selecting information of behavior or affect of “Guide”, “Scold” and “Not remember”. Then, “Scold” is selected in FIG. 10.

Additionally, on the reception screen 42, radio buttons are shown indicating a degree of reaction of a caregiver of “None”, “Weak” and “Strong” for information of behavior or affect of “Rejection”, “Anger”, “Abandonment”, “Sadness” and “Anxiety”. Then, the radio button of “Weak” is selected for “Anger”.

That is, this example shows that the caregiver takes on the behavior of “Scold” for the patient, and information of “Scold” and information that the caregiver feels weak anger are thus input as behavior/affect information of the caregiver.

In this case, information of “YES” as information of an answer of the caregiver, information of “Scold” as information of behavior or affect of the caregiver and information of “Anger, Weak” will be transmitted to the dementia care support apparatus 20.

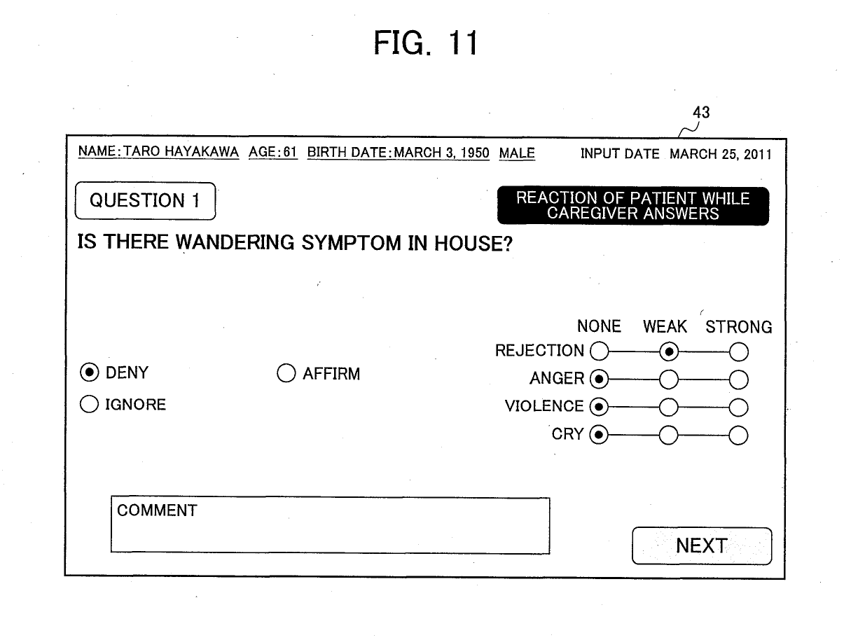

FIG. 11 is a diagram showing an example of a reception screen 43 for receiving information of behavior or affect of a patient when a caregiver answers. In FIG. 11, an example of the reception screen 43 is shown for receiving information of behavior or affect of a patient when a doctor asks the caregiver a question that “Is there a wandering symptom in the house?” and the caregiver answers “Yes”.

On the reception screen 43, check boxes are shown for selecting information of behavior or affect of “Deny”, “Affirm” and “Ignore”. Then, “Deny” is selected in FIG. 11.

Additionally, on the reception screen 43, radio buttons are shown indicating a degree of reaction of a patient of “None”, “Weak” and “Strong” for information of behavior or affect of “Rejection”, “Anger”, “Violence” and “Cry”. Then, the radio button of “Weak” is selected for “Rejection”. That is, this example shows that there is a situation where a patient feels weak rejection with respect to an answer of the caregiver that the patient wanders in the house.

In this case, as information of behavior or affect of the patient for the answer of “YES” of the caregiver to the question, information of “Deny” and information of “Rejection, Weak” will be transmitted to the dementia care support apparatus 20.

In this manner, information of answers of a patient, a caregiver or both a patient and a caregiver as well as behavior or affect of a patient and a caregiver while the patient answers a question and information of behavior or affect of a patient and a caregiver while the caregiver answers a question are transmitted to the dementia care support apparatus 20, thereby making it possible for the dementia care support apparatus 20 to select an appropriate way of coping in consideration of intelligibility of a caregiver for a patient and a relation between a patient and a caregiver.

For example, in the examples of FIG. 8 to FIG. 11, a patient wanders in the house in daily life, however, lacks consciousness thereof, about which a caregiver scolds and expresses anger, which is rejected by the patient, while the caregiver feels angry at the patient who wanders in the house.

For such a patient and a caregiver, there is a need to provide an explanation of a situation where the patient wanders in the house and an explanation of the cause, and devices and countermeasures for improving such a symptom. For example, when the degree of progress of dementia (core symptom) of a patient is “amnesia”, the dementia care support apparatus 20 may output to the terminal device 10 information that “The patient looks for something, however, has a possibility not to understand what he/she is looking for, thus please act together with the patient.”

Additionally, when the degree of progress of dementia of a patient is “agnea”, the dementia care support apparatus 20 may output to the terminal device 10 information that “A patient may look for something, and even in the case of being found, not understand what it is, and no longer understands the place which is finished looking for. Please act with a patient while explaining him/her.”

Further, when the degree of progress of dementia of a patient is “aphasia”, the dementia care support apparatus 20 may output to the terminal device 10 information that “The patient does not understand what others around him/her talk about and is in a state of confusion, anxiety and tension, then feels uncomfortable. Please sometimes talk to him/her with smile, or recommend fruits or the like that the patient really likes for calming down him/her, then sit down together.” Here, information that the patient really likes fruits may be included in patient information in advance, and obtain the information from the patient information to be embedded in countermeasure information.

Additionally, when information of behavior or affect of a caregiver while a patient answers a question is “Deny”, and information of behavior or affect of a caregiver while the caregiver answers a question is “Scold”, the dementia care support apparatus 20 may refer to the countermeasure data 203f, and reads information that “Please show the patient understanding and sympathy.” as information corresponding to the information of behavior or affect of the caregiver of “Deny” and the information of behavior or affect of the caregiver of “Scold” to be transmitted to the terminal device 10 for presenting the caregiver.

Furthermore, when information of behavior or affect of a patient while a caregiver answers a question is “Rejection, Weak”, the dementia care support apparatus 20 may refer to the countermeasure data 203f, and reads information that “Please act asking the patient whether to allow to act together.” as information corresponding to the information of behavior or affect of the patient of “Rejection, Weak” to be transmitted to the terminal device 10 for presenting the caregiver.

In this manner, in the present system, it is possible to present countermeasures suitable for a patient and a caregiver from information of answers of a patient, a caregiver, or both a patient and a caregiver as well as behavior or affect of a patient and a caregiver while the patient answers a question, information of behavior or affect of a patient and a caregiver while the caregiver answers a question, and the like.

Hereinbefore, embodiments of the terminal device 10, the dementia care support apparatus 20 and a dementia care support method has been mainly described so far, however the present invention is not limited to these embodiments, and the present invention may be implemented as a form of a computer program for realizing functions of the terminal device 10 and the dementia care support apparatus 20, or a form of a computer-readable recording medium in which the computer program is recorded.

Here, as the recording medium, various forms are able to be employed such as a disk system (for example, magnetic disk, optical disk and the like), a card system (for example, memory card, optical card and the like), a semiconductor memory system (for example, ROM, nonvolatile memory and the like) and a tape system (magnetic tape, cassette tape and the like).

Computer programs for realizing functions of the terminal device 10 and the dementia care support apparatus 20 in the above-described embodiments, or a computer program for causing a computer to implement the dementia care support method are recorded on these recording media to be distributed so that it is possible to improve reduction in cost, portability and versatility.

Then, the above-described recording medium is mounted on a computer and reads a computer program which is recorded in the recording medium by the computer to be stored in a memory, then a processor (CPU: Central Processing Unit, MPU: Micro Processing Unit) equipped with the computer reads from the memory and implements the computer program, so that it is possible to realize the functions of the terminal device 10 and the dementia care support apparatus 20 according to the present embodiments and implement the dementia care support method.

Further, the present invention is not limited to the above-described embodiments, and various changes and modifications are able be made without departing from the spirit of the present invention. For example, in the above-described embodiments, the dementia care support system is comprised of the terminal device 10 and the dementia care support apparatus 20, however not limited thereto, and the dementia care support system may be comprised of one terminal device including functions of the terminal device 10 and functions of the dementia care support apparatus 20. In this case, a storage portion of the terminal device accumulates various data described above and receives addition of data. Further, a user such as a doctor instructs the terminal device via an input portion to update and extract the data accumulated in the terminal device to perform update and extraction of data.

As described above, according to the present invention, it is possible to support a doctor so that the doctor is able to grasp a symptom and the like of a patient by asking questions the patient and a caregiver to present appropriate countermeasures corresponding to the symptom of the patient to the patient and the caregiver. Thereby, a caregiver understands and implements an appropriate countermeasure suitable for a patient so that it is possible to expect that a peripheral symptom of the patient is relieved. Further, it is possible to expect that burdens on a dementia patient and a caregiver are relieved.

1. A dementia care support system for outputting countermeasure information to dementia, comprising:
a storage portion for storing information of questions given to a patient of the dementia or a caregiver of the patient and the countermeasure information to the dementia;
a countermeasure information selection portion for selecting any of the countermeasure information stored in the storage portion based on information of an answer of the patient or the caregiver to the question; and
a countermeasure information output portion for outputting the countermeasure information selected by the countermeasure information selection portion.

2. The dementia care support system as defined in claim 1, wherein
the countermeasure information selection portion selects any of the countermeasure information based on the information of the answer and information of behavior or affect of the patient or the caregiver when a question is given to the patient or the caregiver.

3. The dementia care support system as defined in claim 2, further comprising:
a behavior/affect information alternative setting portion for setting information of behavior or affect to be included in the alternatives based on a frequency of the information of behavior or affect that is received by the text input when the information of behavior or affect of the patient or the caregiver is received by selection from among alternatives or text input.

4. The dementia care support system as defined in claim 1, further comprising:
a question information search portion for searching the information of questions given to the patient or the caregiver based on information of a result of an answer to a question that has been already given to the patient or the caregiver; and
a question information output portion for outputting information of a question that is searched by the question information search portion.

5. The dementia care support system as defined in claim 4, wherein
when a question desired by a user is not searched by the question information search portion, the question information output portion outputs the question input by the user as a question to be given to the patient or the caregiver.

6. The dementia care support system as defined in claim 1, further comprising:
the question information search portion for searching the information of a question given to the patient or the caregiver based on information of degree of progress of dementia of the patient; and
the question information output portion for outputting the information of a question searched by the question information search portion.

7. The dementia care support system as defined in claim 6, wherein
when a question desired by a user is not searched by the question information search portion, the question information output portion outputs the question input by the user as a question to be given to the patient or the caregiver.

8. The dementia care support system as defined in claim 1, further comprising:
an answer alternative setting portion for setting, when the answer is received by any of selection from among alternatives or text input, an answer to be included in the alternatives based on a frequency of the answer that is received by the text input.

9. The dementia care support system as defined in claim 1, further comprising:
an edit information receiving portion for receiving countermeasure information after the editing when countermeasure information that is selected by the countermeasure information selection portion is edited, wherein
the storage portion stores the countermeasure information after editing that is received by the edit information receiving portion.
